(19) United States
(12) Patent Application Publication
(10) Pub. No.: US 2006/0172768 A1
(43) Pub. Date: Aug. 3, 2006

(54) Portable multi-function electronic apparatus having a digital answering function and a method thereof

(76) Inventors: Hsin-Chih Wei, Sindian City (TW); Chih-Ming Chang, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/274,126

(22) Filed: Nov. 16, 2005

(30) Foreign Application Priority Data
Feb. 3, 2005 (TW) 94103398

(51) Int. Cl. H04L 12/58; H04M 1/00; H04M 1/725

(52) U.S. Cl. 455/556.1; 455/412.1

(57) ABSTRACT

A portable multi-function electronic apparatus having a digital answering function and a method thereof is disclosed. The present apparatus solves the problem of the inconvenience of the conventional phone answering machine and increases the digital answering functions of a portable electronic apparatus. The present invention integrates a digital answering circuit into a portable electronic apparatus to increase the functions of the portable electronic apparatus and improve the portability and convenience of using a digital answering device. The portable multi-function electronic apparatus having a digital answering function comprises a signal converting unit, a signal encode/decode unit and a microprocessor unit. The prevent apparatus integrates the digital answering system and the portable electronic apparatus and also increases the functions of portable electronic apparatuses.

### BACKGROUND OF THE INVENTION

1. Field of the Invention

The present invention relates to a portable multi-function electronic apparatus having a digital answering function and a method thereof. In particular, this invention provides a digital answering function in a portable digital electronic apparatus.

2. Description of the Related Art

Since the development of SOC (System On Chip), the individual function provided by each electronic apparatus can be integrated into a single electronic apparatus. The size of memory is also increasing due to the development of semiconductor technology and material science to meet the requirements of users in terms of price and efficiency. Therefore, a variety of portable multi-function electronic apparatuses have become popular in recent years. For example, a portable electronic apparatus is used as MP3 player, hard disk, recorder and radio.

Please refer to FIG. 1, which shows a schematic diagram of a circuit block of a portable electronic apparatus of the prior art. The portable electronic apparatus comprises a microprocessor unit 10 and a memory device 20. The microprocessor unit 10 comprises a digital signal processing unit 103, a DC-to-DC converting unit 101, a memory interface unit 109 and other relative peripheral interface units. The digital signal processing unit 103 calculates and processes the signal. Then, the processing signal is stored in the memory device 20 via the memory interface unit 109. The input/output device connects to the digital signal processing unit 103 via the relative peripheral interface unit and a bus 100.

The microprocessor unit 10 has a DC-to-DC converting unit 101 and the DC-to-DC converting unit 101 provides the working voltage for the circuit units in the microprocessor unit 10. In order to offer a long operational time for the portable electronic apparatus, a battery is needed to provide power and a battery charging control unit 110 or a battery voltage detection unit 111 is also installed in the microprocessor unit 10. In order to display the working status of the portable electronic apparatus to the user, a display device control unit 104 is installed in the microprocessor unit 10 to control and drive the display device 40.

Moreover, the conventional answering machine needs a tape to record incoming calls. As the technology for digital answering has matured, voice data from incoming calls can now be stored in the memory via a digital method. Although the portable electronic apparatus can install an analog-to-digital converting unit 102 in the microprocessor unit 10 to record the voice signal and store the voice signal in the memory device 20, it still can't process the analog voice signal that comes from the telephone.

### SUMMARY OF THE INVENTION

The main objective of the present invention is to provide a portable multi-function electronic apparatus having a digital answering function and a method thereof. The present invention overcomes the inconveniences of the conventional telephone answering machine and adds a digital answering function to portable electronic apparatuses.

In order to achieve the above objective, the present invention provides a portable multi-function electronic apparatus having a digital answering function and a method thereof. The present invention integrates a digital answering circuit into a portable electronic apparatus to increase the function of the portable electronic apparatus and improve the portability and the convenience of the digital answering function.

The portable multi-function electronic apparatus having a digital answering function of the present invention comprises a signal converting unit, a signal encode/decode unit and a microprocessor unit. The portable multi-function electronic apparatus receives and processes analog voice phone signals and stores the signals in a memory device. The portable multi-function electronic apparatus then plays the digital voice phone signals via an output device.

The signal converting unit receives an analog voice phone signal and magnifies/or lessens the analog voice phone signal. The signal encode/decode unit electrically connects to the signal converting unit and operates and controls the encode/decode of the analog voice phone signals. The microprocessor unit electrically connects to the signal encode/decode unit. The microprocessor unit converts the analog voice phone signals that have been encoded/decoded into digital voice phone signals and compresses the digital voice phone signals. The signal encode/decode unit comprises at least one encoder/decoder and at least one encode/decode control unit. The microprocessor unit comprises an analog-to-digital converting unit and a digital signal processing unit. Therefore, the portable multi-function electronic apparatus can receive analog voice phone signals, magnify/lessen the analog voice phone signals, encode/decode the analog voice phone signals, convert the analog voice phone signals into digital voice phone signals, compress the digital voice phone signals, store the digital signals in a memory device, and play the digital voice phone signals via an output device. In order to increase the function of the portable multi-function electronic apparatus, other circuits can be added to the microprocessor unit. For example, a phone connection device is added for connecting the phone with a portable multi-function electronic apparatus having a digital answering function to increase the convenience of using the digital answering function.

The present invention also provides a digital answering method of a portable multi-function electronic apparatus. The method comprises the following steps. Firstly, judging whether the portable multi-function electronic apparatus is connected to a phone line or not, if being not, the portable multi-function electronic apparatus executes other functions other than the digital answering function. If the apparatus is connected to a phone line, it executes the digital answering function of the portable multi-function electronic apparatus on standby status. Next, judging whether the digital answering function is enabled or not (if someone answers the phone or not, when a phone call is coming), if the digital answering function is off, the step of switching the digital answering function of the portable multi-function electronic apparatus go to standby status is repeated. If the digital answering function is on, the voice signal is recorded.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a schematic diagram of the circuit block of a portable electronic apparatus of the prior art;

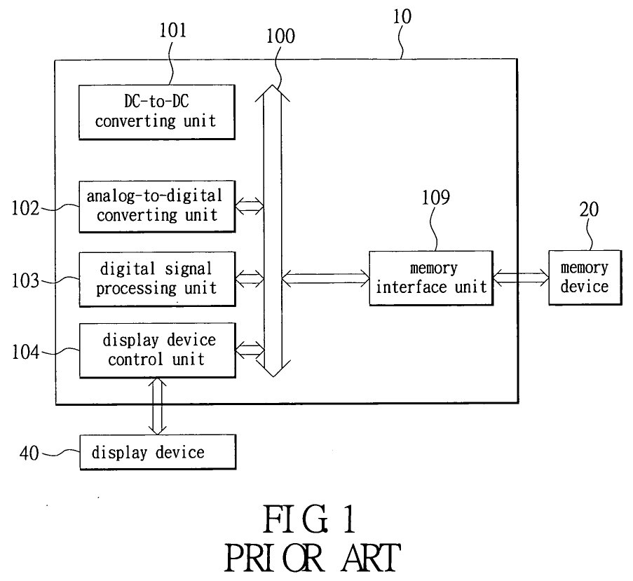

FIG. 2 is a schematic diagram of the circuit block of a portable multi-function electronic apparatus having a digital answering function of the present invention;

FIG. 3 is a schematic diagram of the circuit block of a portable multi-function electronic system having a digital answering function of the present invention;

FIG. 4 is a schematic diagram of the connection of a portable multi-function electronic system having a digital answering function of the present invention; and

FIG. 5 is a flow chart of the digital answering method of the present invention.

### DETAILED DESCRIPTION OF THE PREFERRED EMBODIMENTS

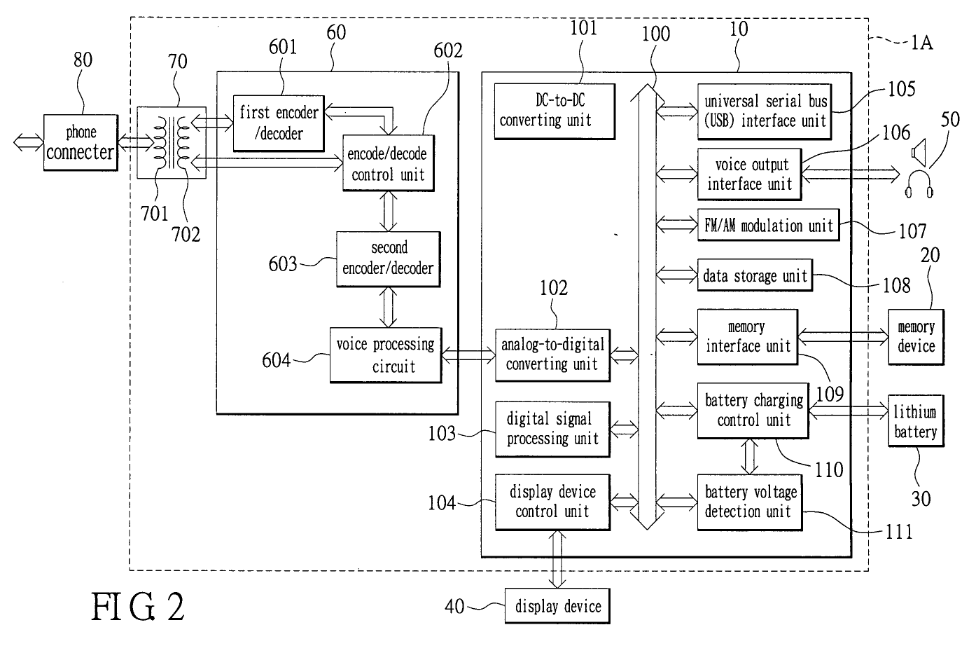

Please refer to FIG. 2, which shows a schematic diagram of the circuit block of a portable multi-function electronic apparatus having a digital answering function of the present invention. The portable multi-function electronic apparatus having a digital answering function 1A of the present invention comprises a signal converting unit 70, a signal encode/decode unit 60 and a microprocessor unit 10. The signal encode/decode unit 60 comprises a first encoder/decoder 601, an encode/decode control unit 602 and a second encoder/decoder 603. The microprocessor unit 10 comprises an analog-to-digital converting unit 102 and a digital signal processing unit 103.

The signal converting unit 70 can be a transformer. After the preliminary side 701 of the transformer receives the analog voice phone signals that come from a phone call, the analog voice phone signals are magnified/lessened and are outputted from the secondary side 702 of the transformer. The signal input/output interface of the analog voice phone signals can be at least one phone connecter 80 (an RJ11 connector). The secondary side 702 of the transformer electrically connects to the signal encode/decode unit 60. The first encoder/decoder 601 encodes the analog voice phone signals and transmits the encoded signals to the encode/decode control unit 602. The encode/decode control unit 602 sets a control command to control the decoding and transmits the encoded signals to the second encoder/decoder 603. After that, the second encoder/decoder 603 transmits the signals to a voice processing circuit 604. The voice processing circuit 604 executes a filtering or magnifying process to the voice signals and transmits to the microprocessor unit 10.

In the microprocessor unit 10, there is a bus 100 for communicating and connecting between units. The analog-to-digital converting unit 102 of the microprocessor unit 10 electrically connects to the signal encode/decode unit 60 and converts the analog voice phone signals that have been encoded/decoded into digital voice phone signals. The digital signal processing unit 103 compresses the digital voice phone signals. Then, the compressed voice phone signals are stored to a memory device 20 via a memory interface unit 109 of the microprocessor unit 10. The memory device 20 is a non-vaporized memory (NVM) for maintaining stored data indefinitely. In order to play the voice data stored in the memory device 20, an output device 50 is electrically connected to the microprocessor unit 10 via a voice output interface unit 106 of the microprocessor unit 10. The output device 50 can be a speaker or an earphone.

In order to make the portable multi-function electronic apparatus having a digital answering function 1A have more functions, the microprocessor unit 10 further comprises a DC-to-DC converting unit 101 to provide the operation voltage for the units. The microprocessor unit 10 also has a universal serial bus (USB) interface unit 105 or an IEEE 1394 interface unit for connecting the portable electronic apparatus 1A with other input/output interface devices. The microprocessor unit 10 has a FM/AM modulation unit 107 to provide a broadcasting function. The microprocessor unit 10 has a data storage unit 108 to temporarily store the relative data via the microprocessor unit 10 and to increase the execution efficiency of the microprocessor unit 10. Moreover, in order to provide the user the status of the portable multi-function electronic apparatus 1A, the microprocessor unit 10 has a display control unit 104 that electrically connects to a display device 40. For supplying power, the microprocessor unit 10 has a battery charging control unit 110 or a battery voltage detection unit 111 that electrically connects to a battery. The battery can be a lithium battery 30.

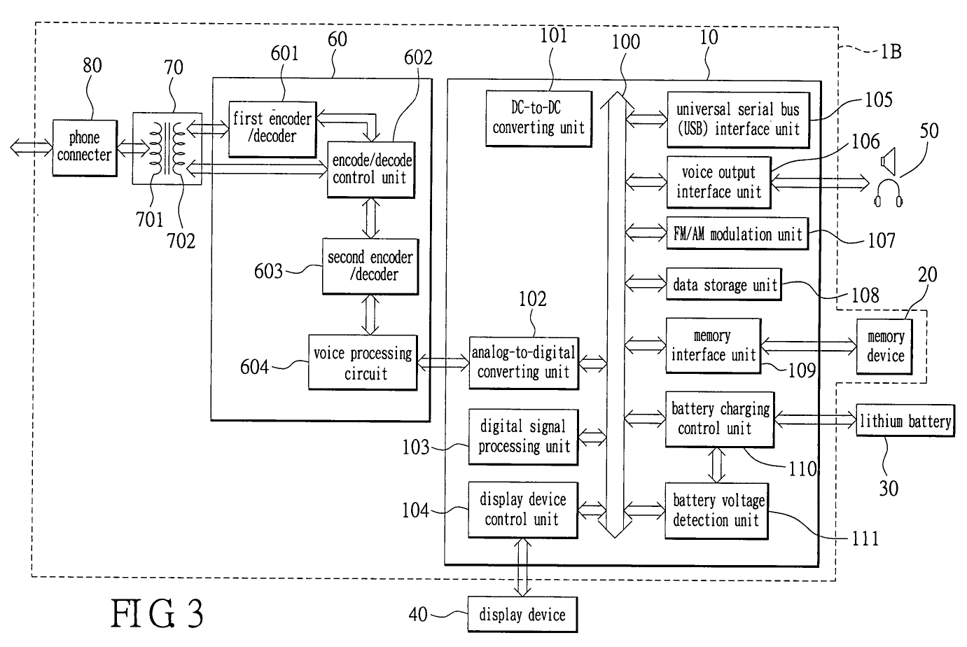

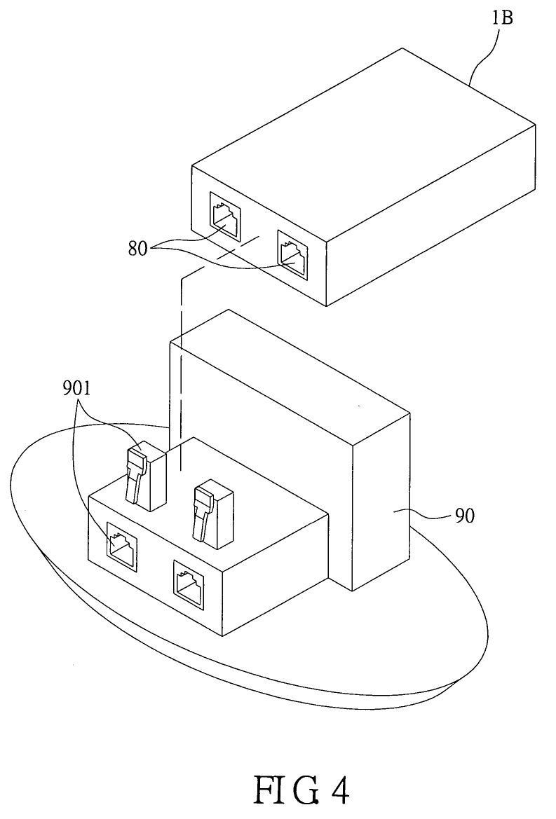

Please refer to FIG. 3. The portable multi-function electronic apparatus having a digital answering function 1A of the present invention integrates the memory device 20 and the phone connector 80 to become a portable multi-function electronic apparatus having a digital answering function 1B. Please refer to FIG. 4, which shows a schematic diagram of the connection of a portable multi-function electronic system having a digital answering function of the present invention. The portable multi-function electronic apparatus having a digital answering function 1B of the present invention further has a transfer connection device 90 for connecting to the phone connector 80 of the portable multi-function electronic apparatus having a digital answering function 1B. The transfer connection device 90 comprises at least one phone connector 901 for connecting with the portable multi-function electronic apparatus having a digital answering function 1B via a phone line.

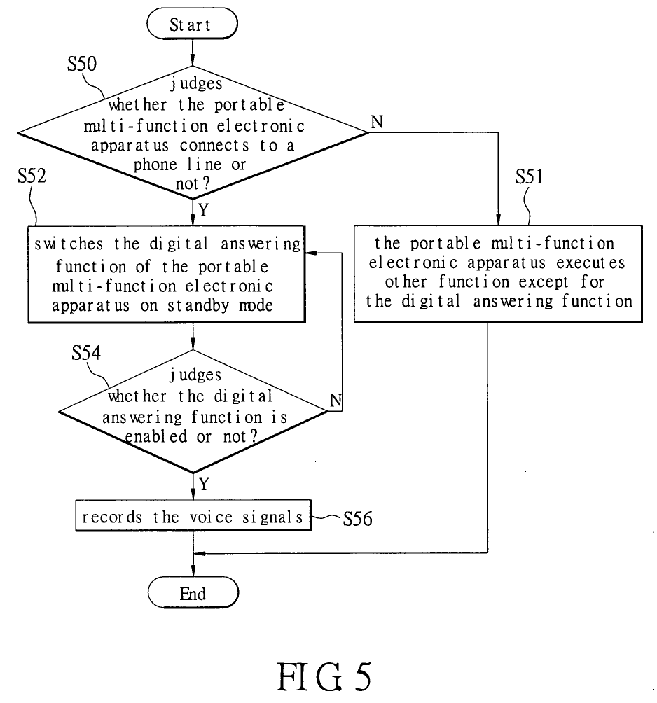

Please refer to FIG. 5, which shows a flow chart of the digital answering method of the present invention. The method comprises the following steps: firstly, judging whether the portable multi-function electronic apparatus is connected to a phone line or not (Step 50), if not, the portable multi-function electronic apparatus executes other functions except for the digital answering function (Step 51). If the portable multi-function electronic apparatus is connected to a phone line, the portable multi-function electronic apparatus executes the digital answering function so that it is in standby mode (Step 52). Next, judging whether the digital answering function is enabled or not (Step 54). If no one answers the phone within a predetermined period of time when a phone call is incoming, enabling the digital answer function to record the voice signals (Step 56). If someone answers the phone within a predetermined period of time when a phone call is incoming, and the digital answering function is off, repeating the step of switching the digital answering function of the portable multi-function electronic apparatus to standby mode (Step 52).

The portable multi-function electronic apparatus having a digital answering function and the method of the present invention integrates the digital answering system to the portable electronic apparatus and increases the number of additional functions that can operated using the portable apparatus. Because the present invention is portable, the user can listen to recorded voice data at any time without a tape. The present invention increases the functions of a portable electronic apparatus by system integration and reduces the inconvenience of the conventional answering system.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A portable multi-function electronic apparatus having a digital answering function, comprising:
a signal converting unit receiving analog voice phone signals, for magnifying/lessening the analog voice phone signals;
a signal encode/decode unit electrically connecting to the signal converting unit, for operating and controlling the encode/decode of the analog voice phone signals;
a microprocessor unit electrically connecting to the signal encode/decode unit, for converting the analog voice phone signals that have been encoded/decoded into digital voice phone signals and compressing the digital voice phone signals;
wherein the signal encode/decode unit comprises:
at least one encoder/decoder for encoding/decoding the analog voice phone signals; and
at least one encode/decode control unit for setting a control command to control the encoding/decoding operation of the encoder/decoder;
wherein the microprocessor unit comprises:
an analog-to-digital converting unit for converting the analog voice phone signals that have been encoded/decoded into digital voice phone signals; and
a digital signal processing unit for compressing the digital voice phone signals;
the portable multi-function electronic apparatus receives the analog voice phone signals, magnifies/lessens the analog voice phone signals, encodes/decodes the analog voice phone signals, converts the analog voice phone signals into digital voice phone signals, compresses the digital voice phone signals, stores the digital signals in a memory device, and plays the digital voice phone signals via an output device.

2. The portable multi-function electronic apparatus having a digital answering function of claim 1, wherein the signal converting unit is a transformer, the memory device is a non-vaporized memory (NVM), the microprocessor unit is a microprocessor or a micro controller.

3. The portable multi-function electronic apparatus having a digital answering function of claim 1, wherein the signal encode/decode unit further comprises a voice processing circuit electrically connecting to the signal encode/decode unit for executing a filtering or magnifying process to the voice signals.

4. The portable multi-function electronic apparatus having a digital answering function of claim 1, wherein the microprocessor unit further comprises a battery charging control unit, a battery voltage detection unit, a FM/AM modulation unit, a data storage unit, a memory interface unit that electrically connects to the memory device, and a display device control unit.

5. The portable multi-function electronic apparatus having a digital answering function of claim 1, wherein the microprocessor unit further comprises a universal serial bus (USB) interface unit or an IEEE 1394 interface unit for connecting the portable electronic apparatus to the output device.

6. The portable multi-function electronic apparatus having the digital answering function of claim 1 further comprising a lithium battery electrically connecting to the microprocessor unit, and a display device electrically connecting to the microprocessor unit.

7. The portable multi-function electronic apparatus having the digital answering function of claim 1, wherein the analog voice phone signal uses a RJ11 interface as an input/output interface of the analog voice phone signal.

8. A portable multi-function electronic apparatus having the digital answering function, comprising:
a phone connection device having at least one connector, for receiving analog voice phone signals;
a signal converting unit electrically connecting to the phone connection device, for magnifying/lessening the analog voice phone signals;
a signal encode/decode unit electrically connecting to the signal converting unit, for operating and controlling the encode/decode of the analog voice phone signals;
a microprocessor unit electrically connecting to the signal encode/decode unit for converting the analog voice phone signals that have been encoded/decoded into digital voice phone signals and compressing the digital voice phone signals; and
a memory device electrically connecting to the microprocessor unit, for storing data coming from the microprocessor unit;
wherein the signal encode/decode unit comprises:
at least one encoder/decoder for encoding/decoding the analog voice phone signals; and
at least one encode/decode control unit for setting a control command to control the encoding/decoding operation of the encoder/decoder;
wherein the microprocessor unit comprises:
an analog-to-digital converting unit for converting the analog voice phone signals that have been encoded/decoded into digital voice phone signals; and
a digital signal processing unit for compressing the digital voice phone signals;
the portable multi-function electronic apparatus receives the analog voice phone signals, magnifies/lessens the analog voice phone signals, encodes/decodes the analog voice phone signals, converts the analog voice phone signals into digital voice phone signals, compresses the digital voice phone signals, stores the digital signals in a memory device, and plays the digital voice phone signals via an output device.

9. The portable multi-function electronic apparatus having the digital answering function of claim 8, wherein the signal converting unit is a transformer, the memory device is a non-vaporized memory (NVM), and the microprocessor unit is a microprocessor or a micro controller.

10. The portable multi-function electronic apparatus having the digital answering function of claim 8, wherein the signal encode/decode unit further comprises a voice processing circuit electrically connecting to the signal encode/decode unit, for executing a filtering or magnifying process to the voice signals.

11. The portable multi-function electronic apparatus having the digital answering function of claim 8, wherein the microprocessor unit further comprises a battery charging control unit, a battery voltage detection unit, an FM/AM modulation unit, a data storage unit, a memory interface unit, and a display device control unit.

12. The portable multi-function electronic apparatus having the digital answering function of claim 8, wherein the microprocessor unit further comprises a universal serial bus (USB) interface unit or an IEEE 1394 interface unit for connecting the portable electronic apparatus with the output device.

13. The portable multi-function electronic apparatus having the digital answering function of claim 8 further comprising a lithium battery electrically connecting to the microprocessor unit, and a display device electrically connecting to microprocessor unit.

14. The portable multi-function electronic apparatus having the digital answering function of claim 8, wherein the phone connection device comprises at least one RJ11 connector.

15. The portable multi-function electronic apparatus having the digital answering function of claim 8 further comprising a transfer connection device connecting to the phone connection device, for connecting with the portable multi-function electronic apparatus having a digital answering function.

16. The portable multi-function electronic apparatus having the digital answering function of claim 15, wherein the transfer connection device comprises at least one RJ11 connector.

17. A digital answering method for a portable multi-function electronic apparatus having a digital answering function, the steps of the method comprising:
judging whether the portable multi-function electronic apparatus is connected to a phone line or not;
switching the digital answering function of the portable multi-function electronic apparatus to standby mode;
judging whether the digital answering function is enabled or not; and
recording the voice signals.

18. The digital answering method of claim 17, wherein the step of judging whether the portable multi-function electronic apparatus is connected to a phone line or not, if not, the portable multi-function electronic apparatus executes other functions except for the digital answering function, if the portable multi-function electronic apparatus is connected to a phone line, switching the digital answering function of the portable multi-function electronic apparatus to standby mode.

19. The digital answering method of claim 17, wherein the step of judging whether the digital answering function is enabled or not, if it is enabled, recording the voice signals, if the digital answering function is disabled, repeating the step of switching the digital answering function of the portable multi-function electronic apparatus to standby mode.

20. The digital answering method of claim 17, wherein the step of judging whether the digital answering function is enabled or not, judging whether someone has answered the phone within a predetermined period of time when a phone call is incoming.
